(19) United States
(12) Patent Application Publication
(10) Pub. No.: US 2025/0120522 A1
(43) Pub. Date: Apr. 17, 2025

(54) PRINT DISPLAY MEMBER AND METHOD FOR REPLACING A PRINT THEREFROM

(71) Applicant: Mixtiles Ltd., Tel Aviv (IL)

(72) Inventors: David SPECTRE, Tel Aviv (IL); Ziv BOTZER, Karkur (IL); Bar DAVIDOVICI, Tel Aviv (IL); Nirit ZARSKI, Tel Aviv (IL)

(21) Appl. No.: 18/911,453

(22) Filed: Oct. 10, 2024

Related U.S. Application Data
(60) Provisional application No. 63/589,681, filed on Oct. 12, 2023.

(51) Int. Cl. A47G 1/06

(52) U.S. Cl. CPC A47G 1/0644; A47G 2001/0672

(57) ABSTRACT

The present disclosure relates to a print display system designed to securely display and facilitate easy manipulation of a print. The system includes a print display member with a print support surface that is equipped with an attachment mechanism for releasably securing a print in place. The display system is further provided with a lifting mechanism operable between two positions: a first position where the print support surface remains in a planar configuration, and a second position where a movable section of the print support surface is lifted. The lifting mechanism is configured to raise the movable section to allow for manipulation of the print, such as repositioning, removal, or replacement, without damaging the print or the display member.

### CROSS-REFERENCE TO RELATED APPLICATIONS

This application claims priority to U.S. Provisional Patent Application No. 63/589,681 filed on Oct. 12, 2023, the disclosure of which is incorporated herein, in its entirety, by this reference.

### TECHNOLOGICAL FIELD

The present disclosure generally relates to print display systems, particularly to the manner in which prints are secured and removed. More specifically, the present disclosure pertains to a print and a magnetic print display member having a lifting mechanism to enable detachment or replacement of the print therefrom.

### BACKGROUND

Prints or photos are often displayed on walls or other surfaces using frames or other structures. Traditionally, prints are fixed onto a frame, which is then mounted onto the wall or other surfaces. However, this conventional method of displaying prints presents several challenges. Therefore, nowadays, use of magnetism in securing prints to the frames or the structures for print displaying has gained increased attention due to its simplicity. Despite the widespread use of such methods, the prints attached to a frame via a magnetic attachment are often difficult to manipulate and remove due to a strong magnetic attraction. This results in inconvenience and potential damage to the prints when for example attempts are made to remove them from the frame. Additionally, it is problematic when it is desirable to frequently change the prints, such as in a commercial setting where displays are regularly updated or in a personal setting where individuals wish to frequently change the displayed imagery.

Therefore, a need exists for a print and a print display member that enables easy replacement of the print therefrom.

The following references may be considered to be relevant as background art to the presently disclosed subject matter:
US2010083548
U.S. Pat. No. 10,376,077
KR200443480
US2010139140
KR100987907
U.S. Pat. No. 3,680,239
CA2607484
US2004111944

It will be appreciated that acknowledgement of the above references is not to be inferred as meaning that these are in any way relevant to the patentability of the presently disclosed subject matter.

### SUMMARY

In accordance with an aspect of the disclosed subject matter, there is provided a print display system for displaying a print, comprising:
a print display member having a print support surface; and
a lifting mechanism operably engaged with the print support surface, being operable between a first position, wherein the print support surface remains planar, and a second position, wherein the lifting mechanism is configured to lift at least a movable section of the print support to facilitate manipulation of the print relative the print display member.

In accordance with another aspect of the disclosed subject matter, there is provided a print display system for displaying a print, comprising:
a print display member, the print display including a print support surface provided with an attachment mechanism for supporting a print in a releasably secured manner thereon; and
a lifting mechanism operable between a first position, wherein the print support surface remains planar, and a second position, wherein the lifting mechanism is configured to lift a movable section at the print support to facilitate manipulation of the print relative to the print display member.

In accordance with another aspect of the disclosed subject matter, there is provided a magnetic display system, comprising: a print display member with a print support surface for supporting a print flat over the print support and wherein the print is magnetically attractable to said print support surface; a lifting mechanism for lifting at least a portion of the print support surface to facilitate removal of the print from the print display member.

In accordance with yet another aspect of the disclosed subject matter, there is provided a magnetic frame system, comprising: a print display member with a print support surface; a print configurable for flat placement over the print support and wherein the print is magnetically or otherwise attracted to said print support surface; a lifting mechanism for lifting a corner portion of the print support surface to facilitate removal of the print from the print display member.

Another aspect of the disclosed subject matter provides a lifting mechanism system comprising a lifting plate and a lifting mechanism operable between a first position, wherein the lifting plate remains planar, and a second position, wherein the lifting mechanism lifts a lifting plate relative to a fixed section.

Yet an aspect of the disclosed subject matter provides a display system for displaying a print, comprising:
a frame;
a print display member configured to be seated and retained within the frame, the print display member having a front section and a rear section;
at least two spaced connection points pivotally attaching the print display member to the frame, the connection points defining a pivot axis about which the print display member is capable of rotational movement relative to the frame; and
an angled portion formed in the rear section of the print display member, configured to facilitate rotational displacement when user-applied pressure is exerted near or at the angled portion;
wherein application of pressure causes the print display member to partially rotate about the pivot axis, resulting in displacement of the angled section rearwardly relative to the frame.

Any one or more of the following features, designs and configurations can be applied to any system according to the aspects of the present disclosure, separately or in various combinations thereof:
The print display member has a top surface and a bottom surface, wherein the top surface has a print support surface extending thereon, and wherein the movable section forms a movable part to the top surface of the print display member and wherein the lifting mechanism is provided between the top surface and the bottom surface of the print display member, such that the lifting mechanism is operably engageable with the movable section, allowing it to move between the lifted and planar configurations.
The print display system is configured to be mounted on a surface.
The print display system is configured to be a free-standing system.
The print display system comprises a frame configured to extend at least along the edges of the print display system.
print display member is nested in a frame.
The attachment mechanism is selected from one or more of: a magnetic attraction between the print and the print support surface; adhesive; static electricity; and/or a mechanical attachment.
The magnetic attraction between the print support surface and the print can be facilitated by one or more of the following options: the print is made of, or comprises at least a ferrous surface portion attractable to a print support surface configurable with at least a magnetic portion; the print is made of, or comprises, at least a magnetic portion attractable to a print support surface made of or comprising at least a ferrous portion; a print wherein at least a portion the media applied to the print is ferrous and the print support surface made of or comprising magnetic portion.
   The movement of the movable section is facilitated by hinged connection.
   The movable section is a corner section of the print display member.
   The movable section is an integral part of the print support surface.
   The movable section is an add-on to the print display member, such that the movable section can be removed or replaced if needed, it can be attached or received by the print display member at a designated section thereof.
   The print display member comprises an actuation element configured to be engaged by a user, wherein the actuation element is positioned proximate to the movable section of the print support.
   The actuation element is operatively connectable to the movable part of the print support.
   The lifting mechanism is operatively associated with the movable section and the actuation element, wherein the lifting mechanism is configured to cause displacement of said movable section in response to engagement of said actuation element.
   A lifting assembly operable between two positions: a first position in which the print support surface remains planar, and a second position in which the lifting mechanism causes displacement of the movable section or the entirety of the print support in response to engagement of said actuation element.
   The lifting mechanism comprises a biasing element, configured to provide mechanical assistance to the outward displacement of the movable section.
   The lifting mechanism comprises a locking arrangement configured to selectively retain the movable section in an elevated/lifted position and/or the planar position relative to the fixed section of the print support surface.
   The actuation element is a push-to-open actuator that, upon being pressed, releases the locking mechanism to enable upward displacement of the movable section.
   The biasing element comprises any one of a compressible foam, rubber, spring, gas spring, hydraulic lift, or another arrangement configured to reduce the force required to lift the movable section.
   The lifting mechanism comprises a cam, guide rail or hinge assembly that converts the engagement of the actuation element into an outward lifting motion of the movable section.
   The locking mechanism is a push-push mechanism that alternates between a locked and an unlocked position upon engagement thereof.
   The lifting mechanism further comprising a damping element configured to control the speed of the upward displacement of the movable section.
   The print support surface includes hinge-assisted assembly to enable smooth and controlled lifting of the movable section of the print support surface.
   The lifting mechanism is configured to lift a portion of the print from an edge of the print support surface.
   The lifting mechanism is configured to facilitate lifting a portion of the print from a side edge of the print support surface.
   The attachment mechanism comprises a magnetic portion on the support surface and a ferrous portion on the print, allowing the print to be secured magnetically.
   The attachment mechanism comprises a static electricity-based attachment, wherein the support surface comprises a material capable of holding a static charge, and the print is at least partially held against the support surface using static electricity.
   The print support surface comprises a material selected from the group consisting of polymeric material, composite material, PVC, acrylic, polystyrene, natural materials such as wood, rubber, foam, cardboard, paper, metal, magnetically attractive material, ferromagnetic material or any combination thereof.
   The lifting mechanism comprises a manual push-type button or a tab positioned on the support surface to allow the user to manually lift a portion of the print support surface.
   The lifting mechanism is spring-assisted to provide a smooth, controlled lifting motion for the movable part.
   The lifting mechanism comprises an electromechanical actuator configured to lift a portion of the print in response to an electronic signal.
   The print display is mountable on a wall surface.
   The print display is mountable on a ceiling surface.
   The print display is mountable on a floor surface.
   The print display is mounted on a floor surface, wherein the lifting mechanism allows for partial lifting of the tile to facilitate cleaning or replacement.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings. In order to better understand the subject matter that is disclosed herein and to exemplify how it may be carried out in practice, embodiments will now be described, by way of non-limiting examples only, with reference to the accompanying drawings, in which:

FIGS. 1-2 illustrate exemplary perspective views of a print display member in accordance with the present disclosure and according to an embodiment.

FIG. 3 illustrates an exemplary perspective cross-sectional view of a lifting mechanism of a print display member in accordance with the present disclosure and according to an embodiment.

FIGS. 4-6 illustrate an exemplary side cross-sectional view of a lifting mechanism of a print display member in accordance with the present disclosure and according to an embodiment.

FIG. 7 illustrates an exemplary view of a lifting mechanism of a print display member in a retracted position accordance with the present disclosure and according to an embodiment.

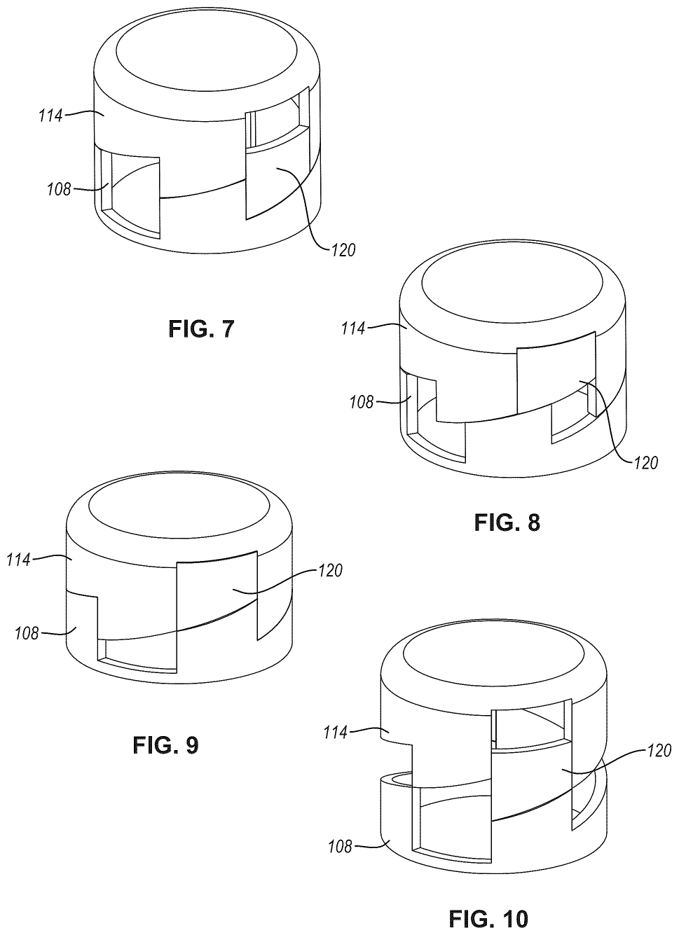

FIGS. 8-10 illustrate different stages of a lifting mechanism of a print display member from a retracted position to an extended position in accordance with the present disclosure and according to an embodiment.

FIGS. 11-14 illustrate different stages of a lifting mechanism of a print display member from an extended position to a retracted position in accordance with the present disclosure and according to an embodiment.

FIGS. 15A-15H illustrate consecutive steps of removing/applying a print over the frame, according to an embodiment.

FIGS. 16A-16B illustrate exemplary perspective views of portion of a print display member in accordance with an example of the present disclosure and according to an embodiment.

FIG. 17 shows the lifting plate of the print display in accordance with the example of the embodiment of FIGS. 16A and 16B.

FIGS. 18A-18F illustrate different stages actuation of a lifting mechanism of the embodiment of FIGS. 16A and 16B.

FIG. 19A is a schematic exploded view of a framed print display system and a print in accordance with an example of the disclosed subject matter.

FIG. 19B is a schematic illustration of the system of FIG. 19A, in a configuration with the print display in its lifted position.

FIGS. 20A and 20B illustrate a cross sectional view of the system of FIG. 19B taken at C-C, showing the stages of actuation of the lifting arrangement.

All drawings are schematic and may not be drawn to scale. Parts assigned a reference number in one figure may be assumed to represent the same parts in other figures, even if the reference number is omitted for brevity, unless they are specifically labeled with a different reference number.

### DETAILED DESCRIPTION OF EMBODIMENTS

The following description provides exemplary methods, processes, systems, techniques, instruction sequences, and applications. It is not intended to limit the scope of the present disclosure but serves to illustrate exemplary embodiments. Specific details are included to aid in the understanding of various embodiments. Not all possible examples of methods, processes, protocols, or structures etc. are shown in detail. Furthermore, the operations described are not restricted to any particular order or sequence unless explicitly stated.

The features and advantages of the disclosed embodiments are described and illustrated by reference to exemplary embodiments, which are to be read in conjunction with the accompanying drawings. The drawings are considered an integral part of this written description. However, the disclosure is not limited to these exemplary embodiments, as they demonstrate some potential non-limiting combinations of features. These features may exist independently or in various combinations with other features.

In the description of the embodiments, any references to direction or orientation (e.g., “rear”, “front”, “horizontal”, “vertical”, “back”, “side”, “perimeter”) are provided for convenience and ease of understanding and are not intended to limit the scope of the disclosed embodiments. Such terms should be interpreted in the context of the particular description or the corresponding figures being discussed. These directional terms are meant solely for illustrative purposes and do not imply that the disclosed embodiments must be constructed or operated in any specific orientation.

Additionally, terms like “attached,” “affixed,” “connected,” “coupled”, “bonded”, “mated”, “engaged”, “attached”, “interconnected” refer to relationships where structures are joined either directly or indirectly, e.g., through intermediate structures, whether the attachment is movable or rigid, unless specifically stated otherwise. In some instances, “print display member,” “magnetic frame,” and “magnetic structure” are used interchangeably.

Reference in the specification to “one embodiment” or “an embodiment” is intended to indicate that a particular feature, structure, or characteristic described in connection with the embodiment is included in at least an embodiment of the disclosure. The appearances of the phrase “in one embodiment” or “an embodiment” in various places in the specification are not necessarily all referring to the same embodiment.

The present disclosure relates to print display system for releasably securing and displaying a print.

It will be appreciated that the term “print”, as used herein, refers to substrates or objects that are at least in part pliable or flexible material that is configured to be attached to the print display system. It will be appreciated that the print as referred herein is not limited to substrate that has been treated with any colorant. In accordance with envisioned embodiments, the print can be a two dimensional or three-dimensional structure, the print having a flat, planar base surface configured for attachment to the print support surface.

The print in accordance with the disclosed subject matter is designed to be easily removable, repositionable, and replaceable without damage to either the print itself or the underlying print support surface of the print display, and its pliability/flexibility allows it to be lifted or manipulated without creasing, breaking, or deforming. The term “print” is intended to cover materials used in a variety of applications, including but not limited to artwork, photographs, printed materials, wall tiles, ceiling tiles, or floor tiles, which may serve decorative, informational, or functional purposes. This includes, but is not limited to, traditional prints such as photographs, artwork, posters, or graphical images, as well as tiles, sheets, panels, or other decorative or functional materials. The print display member has the dimensions and geometrical shape for the suitable application.

Suitable pliable and/or flexible materials for the print materials are plastic films, papers, fabrics, thin metals, polymers, magnet receptive materials, magnetic materials, rubber, PVC, ferrous PET paper, magnetic paper, silicone or combinations thereof and is configured to be attached to the suitable support surface via non-permanent attachment methods, including but not limited to magnetic attraction, ferrous surfaces, static electricity, adhesives, or mechanical means for example hook and loop arrangements. It will be appreciated that when for example the print is a PET ferrous material, the print support surface will have the magnetic properties for magnetic attachment of such ferrous material. In examples where the print is a magnetic material, the print support surface will have magnet attracting surface.

In one embodiment, the print is made from a polymeric film that retains its flexibility and smooth surface even when partially lifted. This ensures that the print can be easily peeled away from the support surface and reapplied without deformation.

It will be appreciated that the flexibility and/or the pliability can further be achieved via mechanical means, such as hinges, living hinges, creases, perforations, etc. Suitable materials for the print include but are not limited to materials which substantially maintain structural integrity even with repeated handling. It will further be appreciated that with some of the embodiments in accordance with the disclosed subject matter, the print can be made from non-flexible or substantially rigid material, e.g., the print can be a sheet of metal, a wood board, cardboard, acrylic plastic, acrylic, plastic, glass, etc.

The material for the print and the at least part of the print display surface of the systems in accordance with the disclosed subject matter are selected such that the print is releasably attachable to the print display member, as discussed and exemplified herein.

The term “frame” as used herein refers to any structure capable of supporting or retaining a print display member, including rigid, semi-rigid, or flexible materials. The frame may be rectangular, square, circular, or any other geometric shape suitable for supporting the display member. The frame can be an integral part of the print display or a separate part therefrom.

The term “print display member” generally refers to any component configured to display or hold a print, printed image, artwork, tile, or other decorative or functional item. This member may be rigid, semi-rigid, or flexible and may be made from materials such as plastic, metal, paper, fabric, foam, cardboard or any other appropriate material.

The system in accordance with the disclosed subject matter and as discussed herein with reference to the accompanying drawings, comprises a print display member having a lifting mechanism to enable detachment or replacement of a print therefrom. The print of the present disclosure is easily manipulated of removed and replaced while the print display member remains on a wall or other surface on which the print display member could be mounted. It will be appreciated that the print display can be free standing display or seated on a holder. The print display member further comprises the lifting mechanism that, when actuated, raises at least a portion of the print display and thus the print attached thereto off from the print display member to allow or enable removal of the print therefrom. The print display member of the present disclosure allows for easy and efficient replacement of prints, providing flexibility and customization for users, and simplifies a process of changing the prints.

As discussed, the system is not limited to traditional print displays, frames etc. It can be adapted for use on walls, ceilings, or floors. In such applications, the print serves not just as a decorative or informative element, but as a functional component in interior design, architecture, or flooring, including soundproofing, insulation and other.

In accordance with one example of the disclosed subject matter, the system comprises a print display with a print support surface, configured for receiving the print, the print being configured to be positioned on the support surface; an attachment mechanism for releasably securing the print to the print support surface; and a lifting mechanism operatively connected to the print support surface, configured to allow for partial lifting of a portion (i.e. movable section) of the print support surface, enabling the removal or replacement of the print. In some embodiments, the entire support system can lift to enable removal or replacement of the print.

In an exemplary embodiment, the presently disclosed subject matter relates to a wall-mountable frame that provides a convenient and secure means for displaying prints or similar media. The frame includes a print display surface with a print support surface, with the print being placed on the print support surface and presented to the viewer. The print is attached to the print support surface using any one of various attachment mechanisms, such as magnetic attraction (e.g., magnets and ferromagnetic materials), adhesives such as removable or repositionable adhesives, pressure-sensitive adhesives, static electricity, mechanical connection such as hook and loop, or similar non-permanent bonding techniques, or combinations thereof. These attachment methods allow for easy replacement of the print without damaging the print, the print display or when provided, the frame surrounding the display.

The lifting mechanism integrated into the structure of the print display, allows for at least partial lifting of the print support surface and the print when attached thereto. This mechanism is designed to facilitate the removal or replacement of the print, providing access for the user to easily remove the print from the print support surface without damaging the print, the frame, the print display or parts thereof or needing to apply excessive force. The lifting mechanism can be manually, electronically, pneumatically or otherwise actuated and operated or assisted by mechanical means, such as biasing element, actuation elements, springs or levers, to provide smooth and controlled motion. It will be appreciated that the lifting mechanism can also be automated and actuated remotely.

In accordance with an example of the disclosed subject matter the print display comprises a print support member. The print support surface in one example is magnetically attractive. In this example, magnetic attraction between the print support surface and a print to be displayed thereby is facilitated by any one of the following options: the print is made of, or comprises at least a ferrous surface portion attractable to a print support surface configurable with at least a magnetic portion; the print is made of, or comprises, at least a magnetic portion attractable to a print support surface made of or comprising at least a ferrous portion; a print wherein at least a portion the media applied to the print is ferrous and the print support surface made of or comprising magnetic portion.

It will be appreciated that while in some examples the print display is described as having a magnetic print support surface, the print support member can alternatively have a surface treated to have an electrostatic charge. Such treatment in accordance with one example is performed using a charged coating.

The print support member is in accordance with another example at least partially coated with an adhesive layer for removable attachment of the print thereto. In other examples, it is further envisioned for the print display member to have mechanical arrangements for attachment of the print to the print support surface. It will be appreciated that in yet another example, the print display and the print support do not comprise an attachment arrangement and the print is provided with the attachment mechanism, such as for example a layer at least partially disposed on the rear side of the print to facilitate the attachment to the print display surface.

The print display member can be formed from any suitable material, as a unitary member or a composition of various layers or parts. The material can include but not limited to plastic, wood, polymeric material, expanded polymer, metal, ferrous, magnetic, paper, cardboard, foam, foam board, reinforced material, composite materials and any combination of materials, including embedding various suitable materials in the print display member or any parts, portions, surfaces thereof.

The system in accordance with the disclosed subject matter employs various attachment methods that allow the print to be easily attached and removed from the print display member.

In accordance with the disclosed subject matter, the print is removably attachable to the print support of the print display member. The print display is provided with an attachment mechanism configured to releasably secure the print to the print support surface of the print display. The attachment mechanism in accordance with the envisioned embodiments comprises one or more of magnetic attachment, for example via the use of a magnet and a ferromagnetic material; adhesive; static electricity-based adhesion; or other non-permanent attachment means.

In accordance with the disclosed subject matter the system is further configured with a lifting mechanism. The lifting mechanism in accordance with an embodiment of the disclosed subject matter is operatively connected to the print support surface of the print display member, configured to facilitate partial lifting of the print support surface, allowing access to the lifted portion thereof and when print is attached, of the print, for removal or replacement of the print.

The lifting mechanism in accordance with the disclosed subject matter is designed to selectively and at least partially lift a part of the print support surface, e.g., a corner, border section of the print surface, allowing for controlled manipulation of the print with minimal effort. It will be appreciated that the lifting mechanism can be configured to lift the entire surface of the print support member. In this connection, the lifting mechanism can also be configured to lift from and distance from the mounting surface the entire print display member or the entire print support surface. The system can operate through various actuation methods, depending on the desired application, including but not limited to the lifting mechanism comprising push, push-push, push-to-open, latching mechanisms, push-latch, lift-up mechanisms and any other suitable mechanism or method.

It will be appreciated that the lifting mechanism can comprise an electronic mechanism. A small servo motor or electromechanical actuator could be triggered by pressing a button or via remote control, providing automated removal functionality. These mechanisms provide smooth, reliable movement while maintaining structural stability of the surface both in its elevated and original positions.

The lifting mechanism in accordance with an example of the disclosed subject matter is designed to selectively elevate the entire surface, a portion, section, or corner of a relatively flat print support surface in response to manual or automated input. This system enables controlled and repeatable manipulation (e.g., easy gripping and removal or repositioning) of the respective portion of the print support surface. The mechanism typically operates via mechanical components such as springs, cams, hinges, or pneumatic assists, and may integrate various types of actuation mechanisms or systems. In accordance with the disclosed subject matter, the lifting mechanism is provided with an integrated locking system configured to maintain the respective surface in its lifted or lowered position, ensuring stability and safety during use.

In accordance with an example, a push mechanism is provided. This mechanism relies on a single actuation point, where the user applies a force to push down on the surface. The applied force triggers a spring-loaded or cam-based lifting system, causing a surface or part thereof such as corner or section of the surface to elevate. The force of the push releases the section upward for access.

In accordance with another example, a push-push mechanism is provided.

In this configuration, the user applies a push to the surface once to unlock and raise the movable part of the print display section. A second push returns the movable part to its original position. This system incorporates a locking mechanism that holds either or both the lifted surface in an elevated position until a second push is applied to retract it or in its original, retracted position. The push-push mechanism is suitable for surfaces requiring periodic access, as it provides both opening and closing functionality with minimal hardware.

In accordance with another example, a hinge-lift mechanism is provided and uses a combination of mechanical hinges and springs. As a corner or section of the flat surface is lifted, the hinges pivot, and the springs or biasing elements assist in elevating the section to the desired height. The mechanism can be designed to lock in place, providing stability and preventing accidental closure/opening.

In yet another example of the disclosed subject matter, the lifting mechanism can be a compressible foam or the like. The movable part of the lifting plate can be hingedly attached to the print support surface and have a latching mechanism to lock the movable part when returning the lifting plate to its planar, non-lifted configuration.

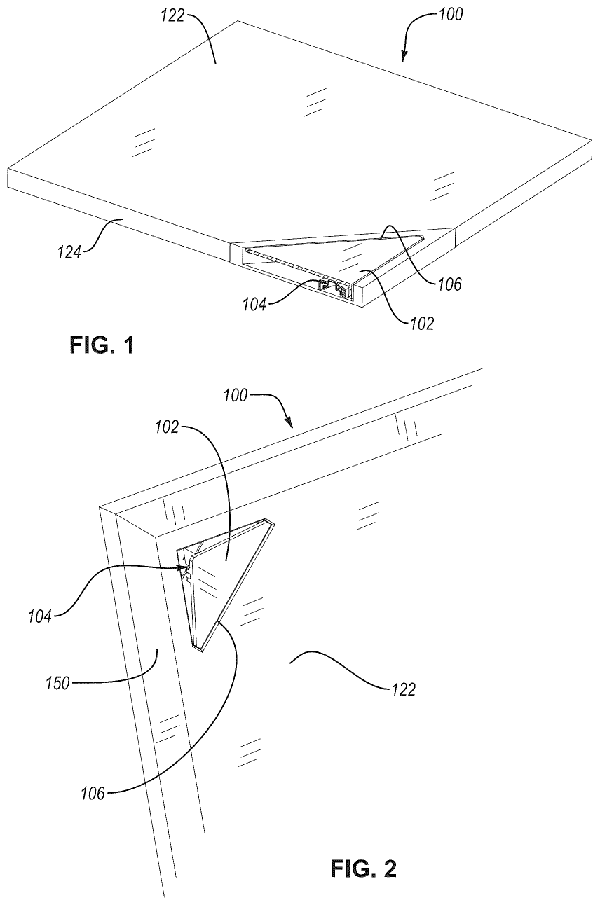

Reference is initially made to FIGS. 1-2, which illustrate exemplary perspective views of a print display member 100 in accordance with an example of the present disclosure. The print display member 100 is configured for receiving a print (not shown) and allowing easy removal of the print therefrom. In some embodiments, the print display member 100 is a magnetic frame or a magnetic structure or a magnetic album. The print may be a photo, an image, or any other suitable article as discussed herein. In an embodiment where the print display member 100 comprises a magnetic surface if the print comprises a ferrous surface.

For example, the print is applied on a ferrous media surface, e.g., ferrous PET paper and a surface of the print display member 100 has at least partial magnetic surface so that the print with the ferrous media surface is attached to the print display member 100 and its surface magnetically. In some embodiments, the print display member 100 comprises a ferrous surface if the print comprises a magnetic surface or comprises magnetic elements. Accordingly, the print is attached or detached from the print display member 100 magnetically. As discussed herein, other types of attachment are envisioned, and appropriate adaptation to the surface or the print display element as well as the print are made. The print display member 100 further comprises a top surface 122, a bottom surface 124, and a lifting mechanism 104. It will be appreciated that only the top surface of the print display may form part to the attachment mechanism, e.g., comprise ferrous elements or be magnetic, as discussed herein. The back surface may be provided with suitable mounting arrangement, depending on the application.

The lifting mechanism 104, shown with an opening in one of its sidewalls is positioned between the top surface 122, and the bottom surface 124 such that the lifting mechanism 104 is positioned behind the print support surface 122 when the print is applied or attached on the print display member 100. In some embodiments, as shown in FIG. 1, the lifting mechanism 104 is positioned on at least one corner of the print display member 100. The lifting mechanism 104 is positioned on a first corner 102 of the print display member 100. It is to be noted that the lifting mechanism 104 may be positioned anywhere on the print display member 100 in such a way that enables easy removal of the print from the print display member 100. While in this example only the corner 102 is lifted, the print support surface can be lifted in full, half, or in any other configuration.

The lifting mechanism 104 is configured to raise or lift at least one corner 102 of the print support surface 122 and thereby the print, when applied, by raising the at least one corner of the print display member 100, thereby facilitating easy removal or replacement of the print from the print display member 100. The corner 102 of the support surface 122 is hingedly connected 106 via a hinge member to the print display member. It will be appreciated that while in this example a hinge 106 is provided, the hinge can be formed as a living hinge on the print support surface. In a normal, resting state, the lifting mechanism 104 is in a retracted position, thereby the at least one corner 102 of the print display member 100 is in a flat position for receiving and attaching the print thereon e.g., magnetically attached. Upon actuation of the lifting mechanism 104, the lifting mechanism 104 is in an extended, second position, thereby raising the at least one corner 102 of the print display member 100, i.e. the movable section of the print support surface, which remains hingedly attached to the print support surface which in turn raises the at least one corner of the print when applied thereon for enabling access to the edge of the print and removal of the print from the print display member 100. It will be appreciated that the corner 102 can be a separate part attached to the print display member fitting the shape and dimensions thereof, and the corner can be raised in parallel to the remaining print support surface. In such an example (not shown) the bottom surface of the corner 102 is engaged with the lifting mechanism and remains attached thereto in both in the first, resting position in which its top surface remains flush with the remaining surface of the print support and in the second, elevated position in which it extends on a plane above the plane of the print support surface, thereby raising the print applied thereon.

The arrangement may further comprise a frame element 150 (e.g., shown in FIG. 2) configured to at least partially hold the print display therein. The frame element may be provided such that no gap is present between the sides of the frame and the sides of the print display member 100 and/or the print display surface and/or the print. In the example illustrated in FIG. 2, the print display member is provided with the frame around its perimeter, having raised sidewalls, forming the frame border. As the print display member is provided with the lifting mechanism 104, the print can have any thickness when applied to the support surface 122 and can be easily attached and removed by manipulating the lifting mechanism 104, which in turn will lift the respective portion of the print applied over the print support surface 102 over the lifting mechanism 104. Thus, access will be allowed to the edge of the print allowing ease of manipulation thereof. Alternatively, the frame element may nest the print display member, with gaps along any one or more of the sides. It will be appreciated that the print display and/or the frame may have and shape and size. While the illustrated example shows a substantially square print display, this is provided for illustrative purposes and any other shape and dimensions are envisioned in accordance with the disclosed subject matter.

In some embodiments, the method of replacing a print from a magnetic print display comprises: applying pressure on the lifting mechanism on a corner of a first print for raising the corner of the print on the print support surface, peeling off the print from a surface of the frame, e.g. disengaging the magnetic attachment, placing a second print on the magnetic surface of the support surface, applying pressure on the lifting mechanism on a corner of the second print so that the lifting mechanism locks back to create a flat surface behind (underneath) the second print. Accordingly, the first print is replaced with the second print.

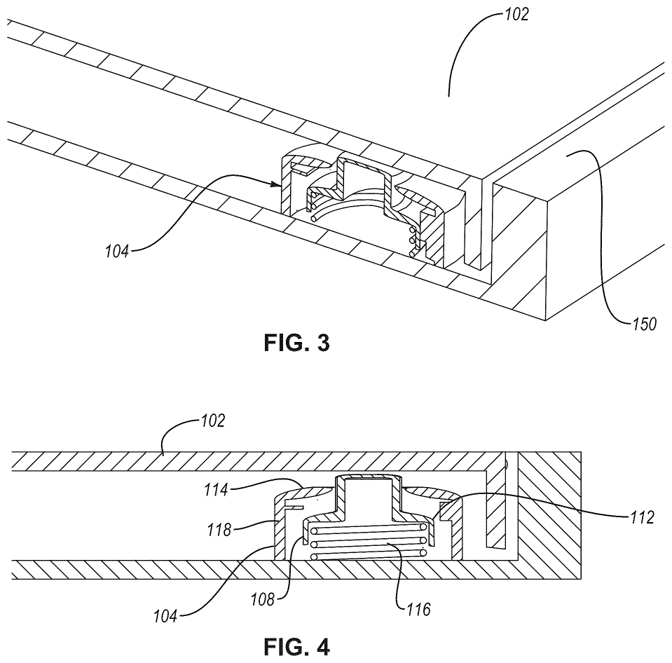

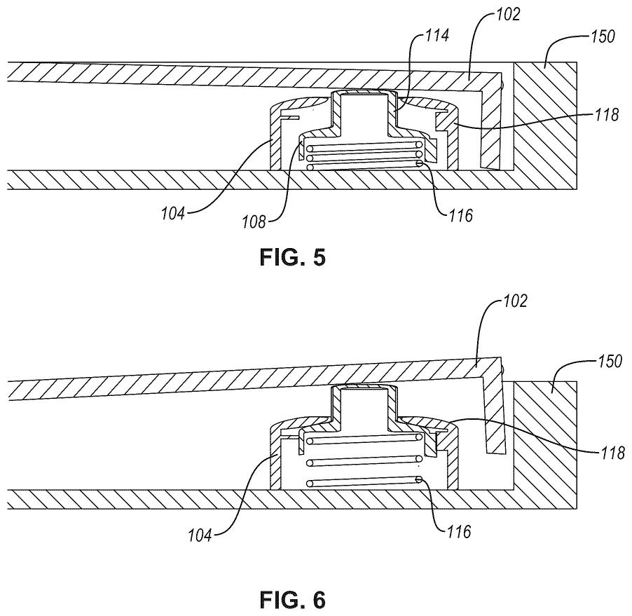

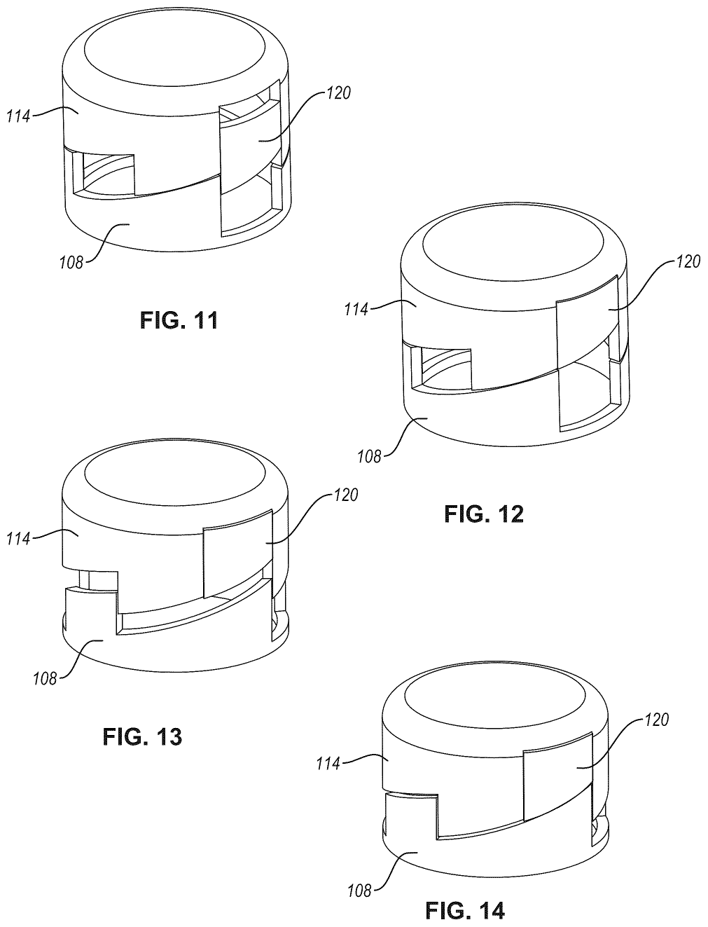

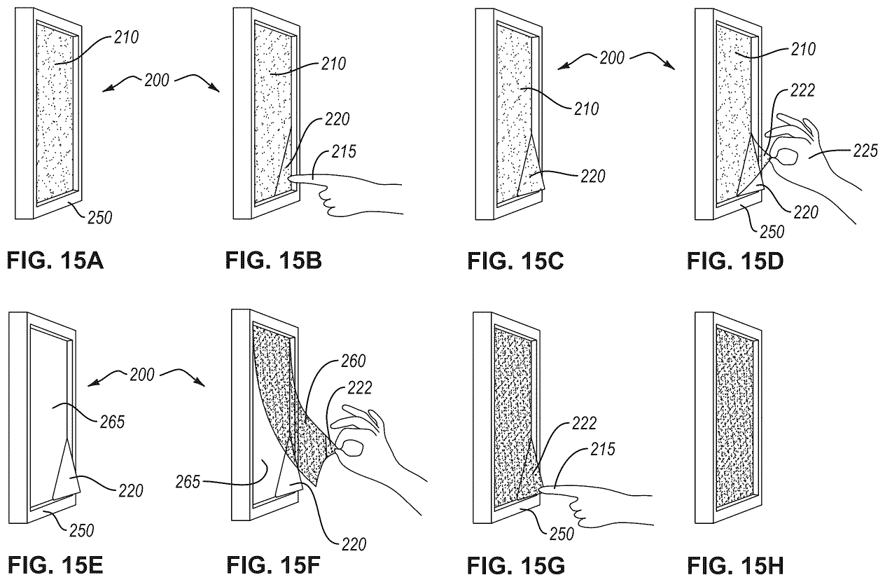

In some embodiments, the lifting mechanism 104 is a push-type mechanism. FIGS. 3-6 illustrates exemplary cross-sectional views of the lifting mechanism of a print display member 100. FIG. 4 illustrates an exemplary side cross-sectional view of the lifting mechanism where the lifting mechanism is in the retracted position. FIG. 5 illustrates an exemplary side cross-sectional view of the lifting mechanism where the lifting mechanism is in a pressed state. FIG. 6 illustrates an exemplary side cross-sectional view of the lifting mechanism where the lifting mechanism is in the extended position and raises the corner of the print display member 100 which in turn raises the corner of the print. The lifting mechanism 104 includes an outer member 118 that houses a rotating cam 108, a stationary cam 112, a spring 116, and a push button 114 (seen e.g., in FIGS. 3-6). During actuation of the lifting mechanism 104, the corner section 102 of the print display member 100 is pressed, thereby the push button 114 is pressed which in turn pushes the rotating cam 108, and the stationary cam 112 until pressing the spring 116. After pressing the spring 116, the spring 116 pushes up the rotating cam 108 to a first height and rotates the rotating cam 108 at a first angle (e.g., 45 degree) in a first direction until the rotating cam 108 strikes with a surface of the stationary cam 112 (seen e.g., in FIGS. 8-9). While releasing the movable section, the corner 102 of the print display member 100, the rotating cam 108 is further pushed to a second height rotates and rotates at a second angle (e.g., 45 degree) in the first direction until the rotating cam 108 mates with a stop member 120, thereby the corner of the print display member 100 is lifted and in raised configuration (seen e.g., in FIGS. 10-11). Similarly, raised corner of the print display member 100 is pressed to lower the corner of the print display member 100 and create a flat surface. During lowering the corner of the print display member 100, the rotating cam 108, the stationary cam 112 and the spring 116 are pressed down. Thereafter, the rotating cam 108 is rotated to engage with the stop member 120 (seen e.g., in FIGS. 12-14).

In some embodiments, the print display member 100 is a magnetic structure mounted on a wall with print. The print is applied on the ferrous media substrate. A face of the magnetic structure mounted on the wall has a magnetic print support surface so that the print with the ferrous media substrate is attached to the magnetic structure's surface magnetically. The magnetic structure is a frameless structure so that the print is configured to be peeled off of the magnetic surface of the structure. Further, the magnetic structure without a print on its surface is placed with another print with the ferrous media substrate, thereby the print is replaced.

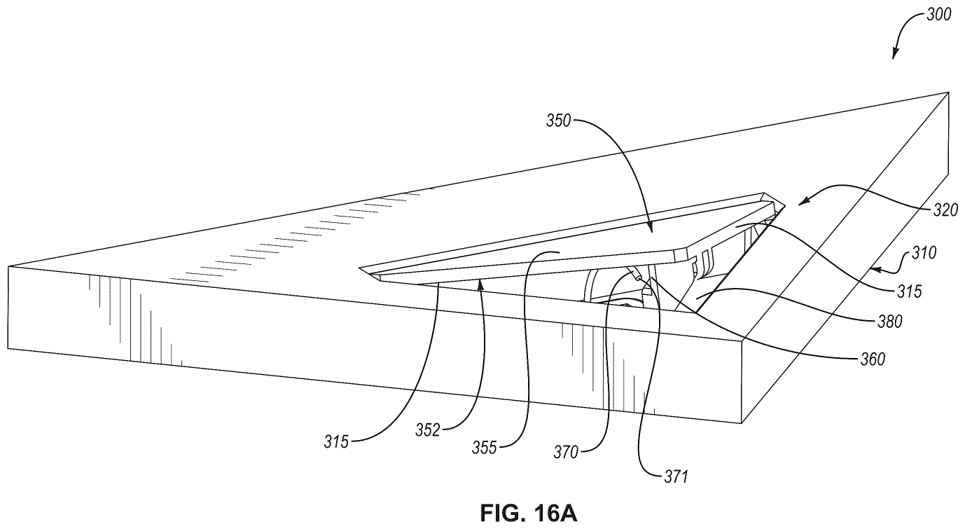

With further attention to FIGS. 15A-15D, there are illustrated consecutive steps of removing/applying a print over the frame. FIG. 15A illustrates a magnetic frame system 200 according to the present disclosure, with a print 210 magnetically attached thereto, at a display position. It will be appreciated that while in this example a frame is provided with the print display system, the discussed steps and sequence can be performed with a frame less system. In FIG. 15B, pressure is applied by user's finger 215 to the respective corner 220 of the print display surface, over the lifting mechanism, resulting in lifting the corner 220 (FIG. 15C), whereby corner 222 of print 210 is exposed and can be easily gripped by user 225 for removal thereof.

FIGS. 15E-15H are a reverse process. First, one obtains a magnetic frame system 200 wherein the corner 255 is already elevated (though it is appreciated that applying a print can be facilitated also with the corner 255 extending coplanar, i.e., not elevated. Then the print 260 is positioned over the print support surface 265 (FIG. 15F), whereupon the corner 255 is pressed by user's finger 215 (FIG. 15G) and arrested at a flat, display position (FIG. 15H).

As shown in this example, the system comprises a frame element designated 250 (FIGS. 15A and 15E). As seen in FIG. 15A, removing or manipulating the print 210 disposed over the print support surface 265 would be challenging or even damaging to the print, in particular with magnetic, adhesive or other attachments as discussed herein, if attempted by the user, in view of the full nesting of the print within the frame borders. This nesting does not allow for a gap that would in turn allow lifting of the print (e.g., print corner) from the print support surface without damaging the same. It will be appreciated that the lifting mechanism of the disclosed subject matter, when actuated allows lifting of at least a portion of the print from the print support surface, in this example from the corner 220 and manipulating thereof.

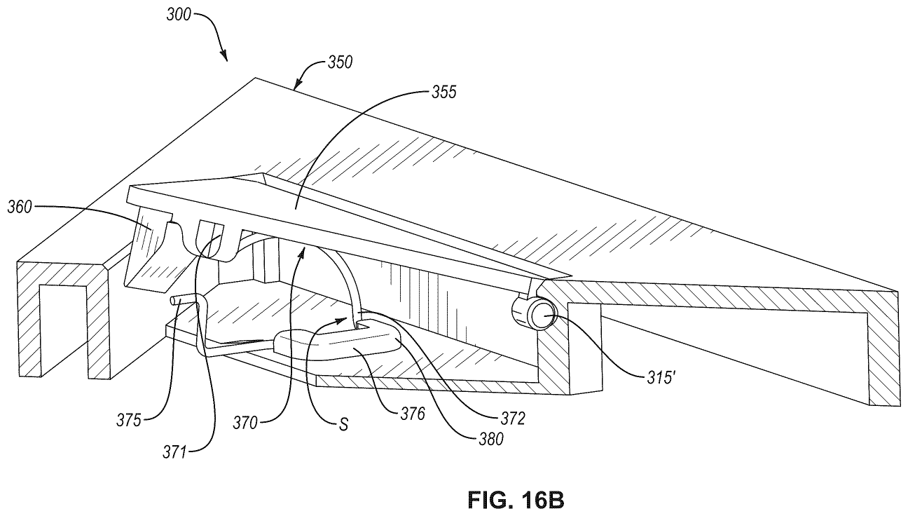

FIGS. 16A-18F, illustrate another example of a lifting mechanism generally designated 350 in accordance with the disclosed subject matter. FIG. 16A illustrates a partial view (a corner) of the print display member generally designated 300 in accordance with the disclosed subject matter. It will be appreciated that the lifting mechanism having similar features and characteristics can be placed along any other portion of the print display member. In this example, the lifting mechanism 350 is provided within the print display member, extending between the rear wall 310 of the print display and the front wall 320, the front wall having the print support surface of the print display member 300. It will be appreciated that the lifting assembly 358 can be an integral part of the print display member or attachable thereto as an add on mechanism. The lifting assembly 358 with the lifting mechanism 350 as seen in FIG. 16A is fitted within a designated and dimensionally compatible space configured to hold the lifting mechanism therein. The lifting assembly in accordance with this example comprises a lifting plate 355, axially rotatably attached to the print display member, such that the lifting plate is surrounded by the print support surface 320.

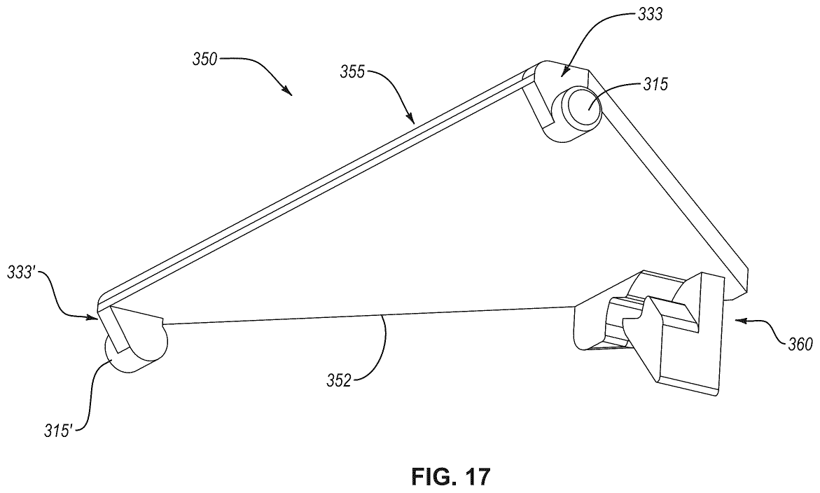

In the example illustrated in FIG. 16A, the lifting plate 355 (best seen in FIG. 17) is connected to the print display member 300 at two points 315 and 315′, allowing for axial and rotational movement of the lifting plate at these points of connection relative the print support surface 320. The lifting plate further comprises stop elements 333 and 333′, integrally formed thereon, to arrest the movement of the lifting plate when activated through the associated lifting mechanism. The stop elements will arrest the movement of the plate when in the lifted, raised, position, and prevent the plate from flipping beyond the designated range, configured through the position, dimensions and shape of the stop elements. It will be appreciated that other arrangements are envisioned for the connecting of the lifting plate to the print display member and the stop elements. The connection can be through a hinge, fold, or other arrangement suitable for the desired action.

The lifting mechanism 350, in accordance with the example of disclosed subject matter, is a push-push mechanism. As will be further discussed with reference to the exemplary drawings, the push-push mechanism comprises a movable component (e.g., a lifting plate) that is operably connected to a guide rail for controlled linear movement. In the illustrated example, the guide rail forms an integral part of the lifting plate on the bottom surface thereof. The movement of the component is further assisted by a guide pin that travels along the guide rail and is associated with an elastic element (such as a spring element). The mechanism is actuated by two successive pushes, each one controlling the position of the movable section. The guide rail serves as a track along which the guide pin travels. It ensures that the guide pin moves in a controlled, linear path, preventing undesired or accidental displacement and allowing for smooth motion of the guide pin between two positions—typically a rest (with the lifting plate lifted) position and an active (lifting plate locked and flush with the print support surface) position.

The elastic element, acting like a spring, stores potential energy when compressed and releases this energy when allowed to expand. It is coupled to the pin such that when the pin moves along the guide rail, the elastic element either compresses (storing energy) or expands (releasing energy). The mechanism includes stop positions at both the raised and lowered positions to prevent overextension or undesired movement of the plate. The stops ensure that the mechanism remains within its intended range of motion, providing reliability and safety in operation.

Now with reference to the illustrations of FIGS. 16A-17, the mechanism includes the lifting plate 355 operably associated with a spring-like element designated S and a guide pin 375 and guide rail 360 system (e.g., as seen in FIG. 16B). Specifically, the bottom side 352 of the lifting plate 355 features an outwardly extending guide rail 360. The spring-like element S and guide pin 375 are positioned underneath the lifting plate 355, with both elements 375 and 355 (configured to engage operably (through the guide rail 360). This configuration enables the controlled movement of the lifting plate 355 between a lowered rest position (e.g., as discussed with reference to FIG. 1) and a raised active position, initiated by sequential push inputs from the user (as further discussed herein).

The spring element S associated with this push-push mechanism 350 stores potential energy and facilitates controlled movement of the lifting plate upon activation of the lifting mechanism.

In one embodiment, the spring element S is a curved, C-shaped component 370, with the bottom surface 352 of the lifting plate 355 resting on the curved portion thereof (as seen in FIGS. 16A and 16B). One end 371 of the C-shaped element remains free, extending downward and away from the lifting plate, toward the rear side of the print display 300, while the opposite end 372 is attached to a base plate 380. The base plate can be integral to the bottom wall of the print display member 300 or configured as a separate element.

In the illustrated example, the connection to the base plate 380 is made via a U-shaped extension 376 linked to the C-shaped spring element S. The extension lies flat over the bottom surface of the print display element, e.g., the base plate 380 and is securely connected thereto. The guide pin 375 extends at an angle from the free end of the U-shaped extension, forming a Z-shape. The unattached, free end of the Z-shape acts as the guide pin 375, enabling it to interact with the guide rail 360 to control the movement of the lifting plate 355.

In one embodiment of the disclosed push-push mechanism, the entire structure of the spring S, U-shaped extension 372, and guide pin 375 is formed from a single continuous piece of metal wire that is folded accordingly to create the desired mechanical functions. This integral design can simplify the manufacturing process and provide the structural integrity of the mechanism.

The metal wire of such design is bent and shaped to form the following key components:

### Spring Element S:

The wire is shaped into a curved, C-shaped portion, which acts as the spring S in the push-push mechanism. This section stores potential energy when compressed and assists in lifting the lifting plate when released. The lifting plate 350 rests on top of this curved section, and the natural flexibility of the metal wire allows it to compress and expand, providing the necessary spring action.

### U-Shaped Extension:

From one end 372 of the C-shaped spring, the wire is further bent into a U-shape member 376. This U-shaped extension acts as a support that lies flat on the base plate or the rear wall of the print display member, forming a stable base that connects the spring to the print display or the base plate structure. The U-shaped section maintains the overall stability of the mechanism, ensuring proper alignment with the rest of the system and connection to the print display member. The U-shaped section in the illustrated example is seated within a securing pocket created on the base plate. It will be appreciated that the U-shaped portion can be secured using other arrangements, such as adhesive or mechanical connectors.

### Guide Pin:

At the end of the U-shaped extension 376, the wire is further bent at an angle to form a guide pin 375, which is configured to slide within the guide rail 360 on the lifting plate. This guide pin controls the movement of the lifting plate as it slides along the guide rail, ensuring smooth, linear motion between the lowered rest position and the raised active position. The guide pin is an integral part of the structure, with no additional fasteners or components required.

The entire structure, when being made from a single continuous metal wire, ensures that all components—the spring, the base, and the guide pin—work seamlessly together to engage the lifting plate and facilitate the push—push lifting and lowering mechanism. The elasticity of the metal wire provides both the spring action needed for the push-push mechanism and the mechanical strength required for the guide pin's interaction with the guide rail 360. It will be appreciated that other types of actuation elements are envisioned and can be torsion spring, compression spring, leaf spring, rubber-based element, foam-based elements, or other biasing element and/or arrangement capable of storing and releasing potential energy and allowing compression and subsequent release of the movable section. Locking arrangements are envisioned to maintain the movable section in its planar configuration and lifted or elevated configuration.

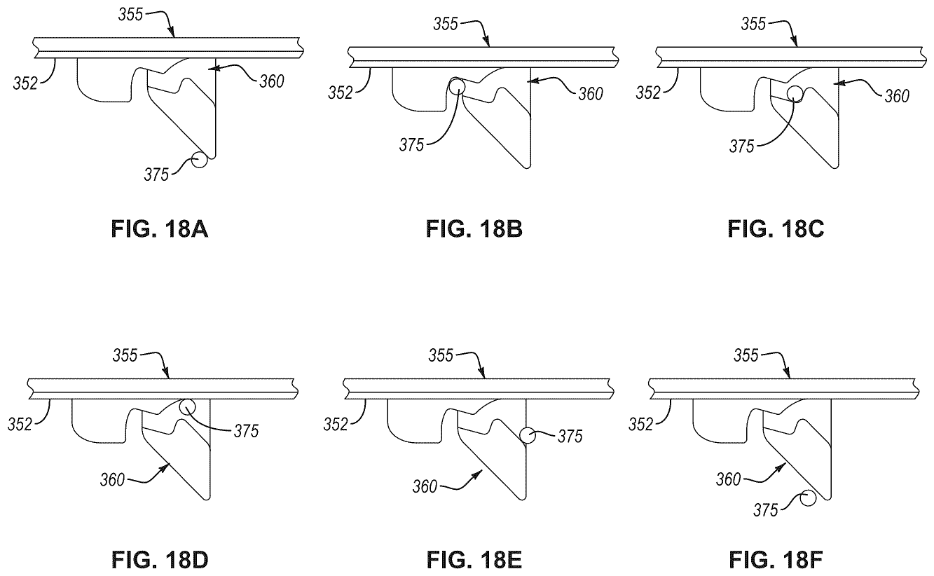

With reference to FIGS. 18A-18F, the operation of the push-push mechanism will be discussed. The figured illustrate schematically the movement of the guide pin with respect to the guide rail in sequential steps. FIG. 18A shows the mechanism with the lifting plate in a lifted, raised position, showing the guide pin 375 outside the guide rail 360. The push in FIG. 18B lowers the lifting plate 355, and pushes (lowers) the guide rail 360 towards the biased guide pin 372, starts compressing (charging with energy) the spring (not seen) and following the entry into the guide rail 360, upon release of the pressure on the plate 355, the guide pin arrests in the tracks of the guide rail and latches therein as seen in FIG. 18C. In FIG. 18D, the lifting plate is pushed second time to lift the lifting plate 355, slidingly guiding the guide pin towards the exit from the guiderail and upon release of the pressure over the lifting plate in FIG. 18E, the guide pin exits the latch as seen in FIG. 18D allowing the spring element to expand and drive the lifting plate from the rest, locked position to the elevated/lifted position, with the guide pin in resting position outside the guide rail as seen in FIG. 18F, returning to the lifting plate to the lifted, elevated position.

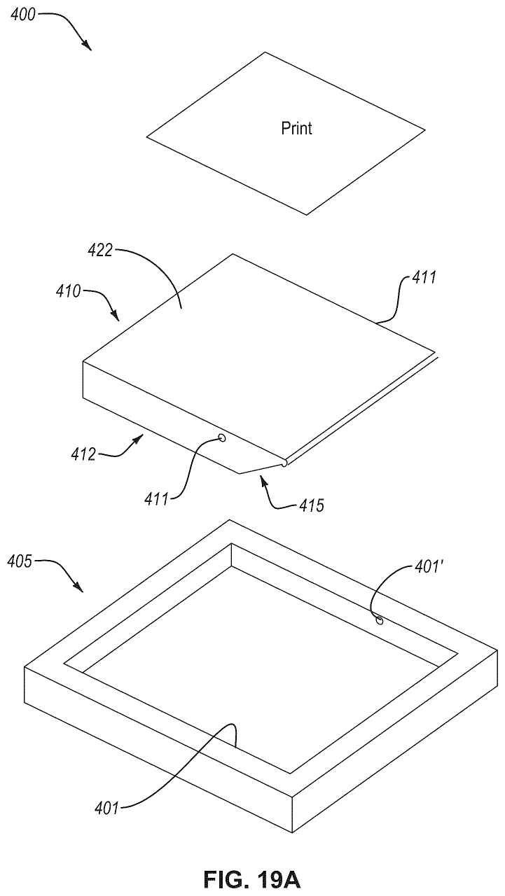

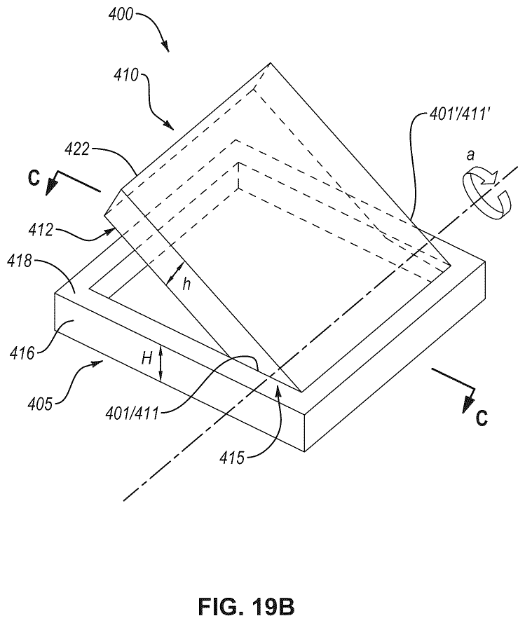

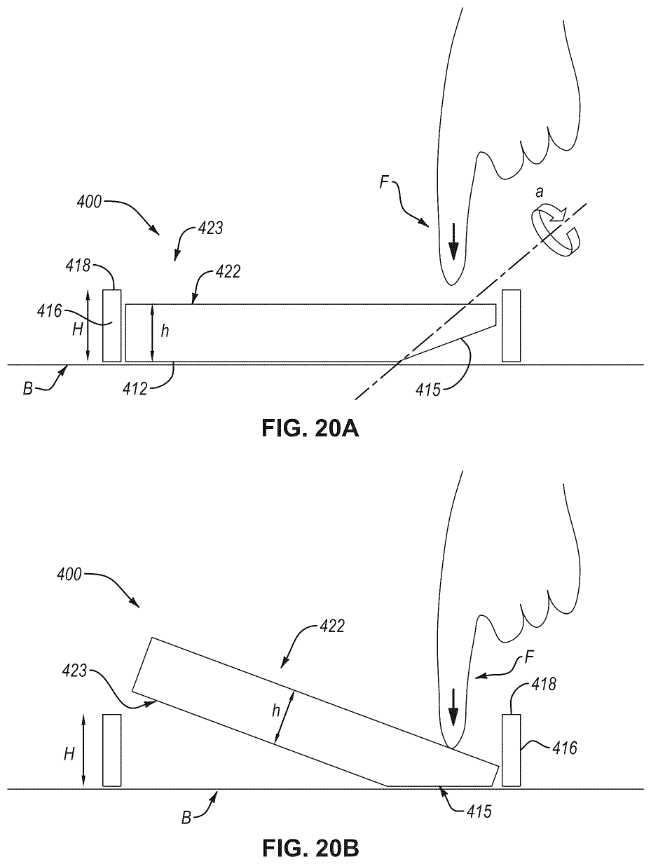

FIGS. 19A-20B illustrate another example of the disclosed subject matter. In this example a print display system, generally designated 400, comprises a frame 405 and a print display member 410 with a print support surface 422 that is configured to the seated and retained within the frame. It will be appreciated that while the illustrated frame 405 is a border frame, namely a frame configured to create a framed border around the display member, a frame with a backing member is also envisioned. Such a frame can be constructed from separate parts or be an integral element, e.g., plastic molded, folded from sheet of material, and the like. The height of the frame H can be such that the print display member when received therein has the print surface extending flush with the surface of the frame walls. The frame walls in the illustrated example (as best seen in FIG. 19B) have the height of the walls H of the frame 405 extending higher that the height h of the print display (its general thickness), thus the surface of the print display 422 extends lower than the edges 418 of the frame wall 416. The print display member 410 is configured to be pivotally attached to the frame at two spaced connection points 411 and 411′ with the frame having the appropriate arrangement at points 401 and 401′, constituting a lifting arrangement. Such arrangement can be for example magnetic with magnetic elements provided on the frame at 401 and 401′ and magnetically attractive parts at 411 and 411′ on the print display 410. It will be appreciated that the print display member can be magnetically attractive structure, e.g., contain ferrous elements embedded in its structure. The connection points, when connected define a pivot axis ‘a’ about which the print display member 410 is capable of limited rotational movement. The movement is limited when for example the angled portion reaches the surface B extending opposite the print display surface, as discussed for example with reference to FIGS. 20A and 20B. This surface can be the backing of the frame, the mounting surface of the system, e.g., wall, floor, ceiling etc.

In accordance with this example, the print display member 410 is formed with a rear section 412 that includes an angled or beveled portion generally designated 415, which serves to facilitate displacement when force is applied to the print display at the respective angled portion. The angled portion 415 may be a recess, cutout, chamfered edge, or other removal of material designed to create a displacement zone that responds to the applied force.

When the user applies force F to the print display member at or near the location corresponding to the beveled portion 415, (seen in FIG. 20A) the print display member rotates about the axis “a” created by the two connection points (seen in FIG. 20B). This rotation results in the beveled rear section 415 of the print display member 410 moving rearwardly relative to the frame towards the surface B, while the opposite section 423 of the print display member 410 is displaced upwardly and forwardly. This creates a lifting action on the front portion 422 of the print display, allowing access to the print when applied and even the back of the display system or any components seated behind it.

The pivotal motion at axis ‘a’ is caused by the displacement of the print display member around the fixed connection points 411/411′ and 401/410′, with the frame 405 acting as a stabilizing structure. The connection points may include hinges, pivots, magnets, or other mechanical fasteners that allow rotational or pivoting movement of the display member relative to the frame.

The “beveled portion” or “angled section” refers to any portion of the print display member that is angled or otherwise modified to facilitate the material free section at that portion that facilitates the displacement when force is applied. This may include recesses, cutouts, or chamfered edges that create an area of reduced thickness or material.

The “user-applied pressure” refers to any manual or mechanical force applied to a designated portion of the print display member, resulting in its rotational displacement about the pivot axis. This pressure may be applied by hand, a tool, or any other mechanical actuator.

The described structure provides a mechanism for allowing the user to lift the support surface of the print display member to access the edges of the print for manipulation thereof, including removal, replacement, adjustment etc., and the disclosure is not limited to the specific embodiments disclosed but includes various configurations that fall within the scope of the disclosed subject matter. It will be appreciated that in accordance with the disclosed subject matter, the print can be non-flexible or substantially rigid material, e.g., the print can be a sheet of metal, a wood board, cardboard, acrylic plastic, acrylic, plastic, glass, etc.

While the above description contains specific details regarding certain elements, embodiments, examples and other teachings, it is understood that embodiments of the disclosure or any combination of them may be practiced without these specific details.

Although various aspects and embodiments are being disclosed herein, other aspects and embodiments, various additions, modifications, and substitutions may be made without departing from the spirit of the disclosed embodiments and are being contemplated. The various aspects and embodiments disclosed herein are for purposes of illustration and are not intended to be limiting.

In particular, it will be clear to those skilled in the art that the presently disclosed subject matter may be embodied in other forms, structures, arrangements, proportions, sizes, and with other elements, materials, and components, without departing from the spirit or essential characteristics thereof. Additionally, numerous variations in the methods and processes described herein may be made within the scope of the present disclosure. One skilled in the art will further appreciate that the embodiments may be used with many modifications of structure, arrangement, proportions, sizes, materials, and components, depending on specific environments and operational requirements, without departing from the principles described herein.

What is claimed is:

1. A print display system for displaying a print, the print display system comprising:
a print display member, the print display member having a print support surface; and a lifting mechanism operably associated with the print support surface, having a first position, wherein the print support surface remains planar, and a second position, wherein the lifting mechanism is configured to lift at least a movable section of said print support to facilitate manipulation of the print relative the print display member.

2. The print display system in accordance with claim 1, further comprising an attachment mechanism for supporting a print in a releaseably secured manner thereon.

3. The print display system in accordance with claim 1, wherein the print display member has a top surface and a bottom surface, wherein the top surface has a print support surface extending thereon, and wherein the movable section forms a movable part to the top surface of the print display member and wherein the lifting mechanism is provided between the top surface and the bottom surface of the print display member, such that the lifting mechanism is operably engageable with the movable section, allowing it to move between the lifted and planar configurations.

4. The print display system in accordance with claim 1, configured to be mounted on a surface.

5. The print display system in accordance with claim 1, further comprising a frame member configured to hold the print display system therein.

6. The print display system in accordance with claim 1, wherein the attachment mechanism is a non-permanent attachment selected from one or more of: a magnetic attraction between the print and the print support surface, adhesive, static electricity, and a non-permanent mechanical attachment.

7. The print display system in accordance with claim 1, wherein the movement of the movable section is facilitated by hinged connection thereof to said print display member.

8. The print display system in accordance with claim 1, wherein the movable section extends at a corner section of the print display member.

9. The print display system in accordance with claim 1, wherein the lifting mechanism is provided with an actuation element configured to be engaged by a user, wherein the actuation element is positioned proximate to the movable section of the print support.

10. The print display system in accordance with claim 8, wherein the lifting mechanism is operatively connectable to said movable section and the actuation element, wherein said lifting assembly is configured to displace said movable section in response to engagement of said actuation element.

11. The print display system in accordance with claim 1, wherein the lifting mechanism further comprises a biasing element configured to provide mechanical assistance to the displacement of the movable section.

12. The print display system in accordance with claim 1, wherein the lifting mechanism further comprises a locking arrangement configured to selectively retain the movable section.

13. The print display system in accordance with claim 8, wherein the actuation element is a push-to-open actuator that, upon being pressed, releases the locking mechanism to enable upward displacement of the movable section.

14. The print display system in accordance with claim 1, wherein the lifting mechanism is a push-push mechanism that alternates between a locked and an unlocked position upon repeated engagement.

15. The print display system in accordance with claim 1, wherein the lifting mechanism further comprising a damping element configured to control the speed of the upward displacement of the movable section.

16. A magnetic frame system, comprising:
a print display member with a print support surface;
a print configurable for placing flat over the print support and wherein the print is magnetically attracted to said print support surface; and a lifting mechanism for lifting at least a portion of the print support surface to facilitate removal of the print from the print display member.

17. A magnetic frame system, comprising:
a print display member with a print support surface;
a print configurable for placing flat over the print support and wherein the print is magnetically attracted to said print support surface; a lifting mechanism for lifting a corner portion of the print support surface to facilitate removal of the print from the print display member.

18. The magnetic frame system of claim 17, wherein magnetic attraction between the print support surface and the print is facilitated by one or more of the following options:
the print is made of, or comprises at least a ferrous surface portion attractable to a print support surface configurable with at least a magnetic portion; the print is made of, or comprises, at least a magnetic portion attractable to a print support surface made of or comprising at least a ferrous portion; or
at least a portion the media applied to the print is ferrous.

19. A print display system for displaying a print, the print display comprising:
a frame;
a print display member configured to be seated within the frame, the print display member having a front section and a rear section;
at least two spaced connection points pivotally attaching the print display member to the frame, the connection points defining a pivot axis about which the print display member is capable of rotational movement relative to the frame; and
an angled portion formed in the rear section of the print display member, configured to facilitate rotational displacement when pressure is exerted near or at the angled portion;
wherein application of pressure causes the print display member to partially rotate about the pivot axis, resulting in displacement of the angled section rearwardly relative to the frame.
